(19) United States
(12) Patent Application Publication
(10) Pub. No.: US 2026/0105342 A1
(43) Pub. Date: Apr. 16, 2026

(54) HYBRID QUANTUM ORCHESTRATION FOR INTEGRATING QUANTUM TECHNOLOGIES

(71) Applicant: International Business Machines Corporation, Armonk, NY (US)

(72) Inventors: Syed Farhan Ahmad, Raleigh, NC (US); Francisco Jose Martin Fernandez, Ridgefield, CT (US); Iskandar Sitdikov, New York, NY (US); Antonio Corcoles-Gonzalez, Mount Kisco, NY (US)

(21) Appl. No.: 18/914,578

(22) Filed: Oct. 14, 2024

(51) Int. Cl. G06N 10/60

(52) U.S. Cl. CPC G06N 10/60

(57) ABSTRACT

One or more systems, devices, computer program products and/or computer-implemented methods of use provided herein relate to quantum orchestration. For example, a system can comprise a memory that can store computer executable components and a processor that can execute at least one of the computer executable components stored in the memory. The at least one of the computer executable components can partition a quantum circuit into a set of sub-circuits. The at least one of the computer executable components can further determine, via an artificial intelligence model, respective qubit modalities for performing the set of sub-circuits based on characteristics of the set of sub-circuits. The at least one of the computer executable components can further schedule hybrid quantum-classical resources across the respective qubit modalities to execute the set of sub-circuits on quantum processors in a set of hybrid nodes.

### BACKGROUND

The subject disclosure relates to quantum computing and, more specifically, to hybrid quantum orchestration for integrating quantum technologies.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that enable hybrid quantum orchestration for integrating quantum technologies are discussed.

According to an embodiment, a system is provided. The system can comprise a memory that can store computer executable components. The system can further comprise a processor that can execute at least one of the computer executable components stored in the memory, where the at least one of the computer executable components can partition a quantum circuit into a set of sub-circuits. The at least one of the computer executable components can further determine, via an artificial intelligence model, respective qubit modalities for performing the set of sub-circuits based on characteristics of the set of sub-circuits. The at least one of the computer executable components can further schedule hybrid quantum-classical resources across the respective qubit modalities to execute the set of sub-circuits on quantum processors in a set of hybrid nodes.

According to various embodiments, the above-described system can be implemented as a computer-implemented method or as a computer program product.

### BRIEF DESCRIPTION OF THE DRAWINGS

One or more embodiments are described below in the Detailed Description section with reference to the following drawings:

FIG. 1 illustrates a block diagram of an example, non-limiting system that can facilitate hybrid quantum orchestration for integrating quantum technologies for integrating quantum technologies in accordance with one or more embodiments described herein.

FIG. 2 illustrates another block diagram of an example, non-limiting system that can facilitate hybrid quantum orchestration for integrating quantum technologies in accordance with one or more embodiments described herein.

FIG. 3 illustrates a diagram of example, non-limiting diagram of a hybrid node in accordance with one or more embodiments described herein.

FIG. 4 illustrates a diagram of example, non-limiting diagram of a quantum unit in a hybrid node in accordance with one or more embodiments described herein.

FIG. 5 illustrates a block diagram of an example, non-limiting system architecture that can facilitate hybrid quantum orchestration for integrating quantum technologies in accordance with one or more embodiments described herein.

FIG. 6 illustrates a block diagram of an example, non-limiting system architecture that can facilitate hybrid quantum orchestration for integrating quantum technologies in accordance with one or more embodiments described herein.

FIG. 7 illustrates a diagram of an example, non-limiting system for determining hardware topologies and qubit modalities of sub-circuits in accordance with one or more embodiments described herein.

FIG. 8 illustrates a diagram of an example, non-limiting reinforcement learning algorithm for training an artificial intelligence model in accordance with one or more embodiments described herein.

FIG. 9 illustrates a diagram of an example, non-limiting workflow of reinforcement learning algorithm for training an artificial intelligence model in accordance with one or more embodiments described herein.

FIG. 10 illustrates a flow diagram of an example, non-limiting method that can facilitate hybrid quantum orchestration for integrating quantum technologies in accordance with one or more embodiments described herein.

FIG. 11 illustrates a flow diagram of an example, non-limiting method that can facilitate hybrid quantum orchestration for integrating quantum technologies in accordance with one or more embodiments described herein.

FIG. 12 illustrates a flow diagram of an example, non-limiting method that can facilitate hybrid quantum orchestration for integrating quantum technologies in accordance with one or more embodiments described herein.

FIG. 13 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

According to an embodiment, a system is provided. The system can comprise a memory that can store computer executable components. The system can further comprise a processor that can execute at least one of the computer executable components stored in the memory, where the at least one of the computer executable components can partition a quantum circuit into a set of sub-circuits. The at least one of the computer executable components can further determine, via an artificial intelligence model, respective qubit modalities for performing the set of sub-circuits based on characteristics of the set of sub-circuits. The at least one of the computer executable components can further schedule hybrid quantum-classical resources across the respective qubit modalities to execute the set of sub-circuits on quantum processors in a set of hybrid nodes.

Such embodiments of the system can provide a number of advantages, including enhancing computational efficiency by providing a strategy to select hardware quantum technology hardware based on a quantum circuit, reducing loss of coherence or fidelity, leveraging advantages of different quantum technologies, and providing diverse quantum hardware technology usage in a single system.

In one or more embodiments of the aforementioned system, the at least one of the computer executable components can further determine, via an artificial intelligence model, respective hardware topologies for performing the set of sub-circuits based on characteristics of the respective qubit modalities.

Such embodiments of the system can provide the advantage of optimizing computational efficiency of algorithms or quantum circuits by reducing latency and improving fidelity across different qubit types.

In one or more embodiments of the aforementioned system, the set of hybrid nodes can comprise respective node controllers to schedule the hybrid quantum-classical resources.

Such embodiments of the system can provide the advantage of enabling automatic scaling of hybrid quantum-classical workloads to improve computational efficiency.

In one or more embodiments of the aforementioned system, the at least one of the computer executable components can further convert a quantum language circuit into a form that can be implemented on the respective hardware topologies.

Such embodiments of the system can provide a number of advantages, including enabling efficient management and orchestration of quantum circuits.

In one or more embodiments of the aforementioned system, the at least one of the computer executable components can further schedule execution of the set of sub-circuits on the set of hybrid nodes based on a queue size or the respective hardware topologies.

Such embodiments of the system can provide the advantage of reducing computation times to improve overall efficiency.

In one or more embodiments of the aforementioned system, the at least one of the computer executable components can further train the artificial intelligence model using reinforcement learning, wherein training the artificial intelligence model using reinforcement learning can comprise generating an image representation of a sub-circuit from the set of sub-circuits. Training the artificial intelligence model using reinforcement learning can further comprise obtaining observations from executing the sub-circuit on a hybrid node. Training the artificial intelligence model using reinforcement learning can further comprise receiving observations as rewards from execution of the sub-circuit on a hybrid node. Training the artificial intelligence model using reinforcement learning can further comprise updating a policy of the artificial intelligence model based on the observations.

Such embodiments of the system can provide the advantages of enabling flexibility of quantum computing by enabling adaptability to different quantum technologies and enabling scalability to larger quantum circuits.

In one or more embodiments of the aforementioned system, the observations can comprise at least one of: a SWAP count, a number of one-qubit gates, a number of two-qubit gates, or a number of idling gates.

In one or more embodiments of the aforementioned system, the rewards can be positive if the SWAP count is reduced, and wherein the rewards can be negative if the observations do not satisfy a performance criterion.

Such embodiments of the system can provide a number of advantages, including enabling learning of quantum hardware for executing quantum circuits based on different quantum backends.

In one or more embodiments of the aforementioned system, the at least one of the computer executable components can further execute the sub-circuit on a noise-free simulator. The at least one of the computer executable components can further obtain the observations from executing the sub-circuit on the noise-free simulator.

In one or more embodiments of the aforementioned system, training the artificial intelligence model using reinforcement learning can comprise executing the sub-circuit on a random hardware topology based on availability.

Such embodiments of the system can provide a number of advantages, including enabling integration of different quantum technologies by intelligently mapping sub-circuits to quantum hardware.

According to various embodiments, the above-described system can be implemented as a computer-implemented method or as a computer program product.

### Definitions

Quantum unit: A quantum unit is a quantum backend of any technology, such as superconducting backends, ion-trap backends, neutral-atom backends, photonic backends, silicon-spin backends, nitrogen-vacancy (NV)-center backends, nuclear magnetic resonance (NMR) backends).
Classical unit: A classical unit is a classical container resource for computation.
Circuit fragmentors: A circuit fragmentor is a tool that decomposes a larger quantum circuit into two or more smaller sub-circuits.

In quantum computing, there are a plethora of quantum hardware technologies and qubit modalities that exist. The rapid advancement of quantum computing has also led to the emergence of new hardware technologies and qubit modalities, each exhibiting unique characteristics and potential applications. (e.g., advancements in hardware research, discoveries of new meta-materials). However, as new quantum hardware technologies and qubit modalities are developed, it is unknown how such technologies will succeed, particularly in terms of scalability, coherence times, error correction schemes, or hardware topology. That is, as such advancements emerge, there's uncertainty on how such new technologies can be best suited for specific quantum algorithms and applications.

Existing methods for orchestrating quantum resources utilize circuit fragmentors to partition larger circuits into smaller sub-circuits. However, such existing methods fall short in providing a comprehensive assessment of the characteristics of the individual sub-circuits. Specifically, existing methods do not offer insights into the suitability of various quantum hardware topologies or qubit modalities for these sub-circuits. This lack of understanding limits the potential for optimizing circuit performance and hinders the effective mapping of sub-circuits onto appropriate hardware architectures.

Furthermore, existing methods are unable to determine the most suitable quantum hardware topologies for each sub-circuit, considering different qubit modalities available. Consequently, without a framework to evaluate the characteristics of the sub-circuits to determine appropriate hardware mappings, the potential advantages of partitioning circuits into smaller sub-circuits are undermined, resulting in inefficient resource allocation, suboptimal performance, and computational inefficiency.

Thus, methods and techniques that can determine suitable quantum hardware topologies and qubit modalities for sub-circuits for computational efficiency and integration of various quantum hardware technologies are desirable.

Various embodiments of the present disclosure can be implemented to produce a solution to these problems. Embodiments described herein include systems, computer-implemented methods, and computer program products that provide a method to orchestrate quantum resources across different qubit modalities and hardware topologies. In particular, various embodiments described herein can determine, via an artificial intelligence (AI) model, respective qubit modalities for performing a set of sub-circuits based on characteristics of the sub-circuits. Accordingly, various embodiments described herein can schedule hybrid quantum-classical resources across the respective qubit modalities to execute the set of sub-circuits. Furthermore, various embodiments described herein can determined respective hardware topologies for performing the set of cub-circuits based on the characteristics of the respective qubit modalities. The various embodiments described herein to orchestrate quantum resources can provide a method for mapping sub-circuits of a quantum circuit to suitable quantum hardware technologies and thus can increase computational efficiency of performing the quantum circuit. Such method can further enable integration of new quantum technologies or qubit modalities by learning, via the AI model, which new quantum technologies are best suited for the quantum circuit. The corresponding results provide a new and more efficient approach to orchestrate quantum resources that can be more reliable and can improve performance of quantum circuits.

In various embodiments, the hybrid quantum orchestration component can be employed to partition a quantum circuit into a set of subcircuits and determine a qubit modality and quantum hardware topology (connectivity of qubits) that is best suited for each sub-circuit. For example, in various embodiments, a hybrid quantum orchestration component can comprise a partition component, a training component, an inference component, a selection component, and a scheduling component. In various embodiments, the partition component can partition a quantum circuit into a set of sub-circuits. In various embodiments, the training component can train an AI model to determine respective qubit modalities for performing the set of sub-circuits based on characteristics of the set of sub-circuits. In various embodiments, the training component can further train an AI model to determine hardware topologies for performing the set of sub-circuits based on characteristics of the respective qubit modalities. In various embodiment, the training component can train the AI model using reinforcement learning.

Accordingly, the inference component can employ the trained AI model to conclude the respective qubit modalities and hardware topologies for any input quantum circuit. Thus, based on availability of hybrid nodes, the selection component can map the sub-circuits to the hybrid nodes, and the scheduling component can schedule the quantum-classical resources to the hybrid nodes that are mapped to the sub-circuits.

In comparison to existing methods, the embodiments described herein for hybrid quantum orchestration provide a more robust system architecture that can leverage the strengths and advantages of different quantum technologies. On the contrary, many existing methods are focused on fragmenting quantum circuits into sub-circuits without scheduling the sub-circuits based on their characteristics. As a result, such existing methods do not address the usage of a multitude of quantum technologies to leverage the strengths of such different quantum technologies. In the various embodiments of the present disclosure, the training and deployment of an AI model for learning most suitable quantum technologies for a particular quantum circuit can provide the advantage of more efficient computation and improved performance, such as reduced coherence loss and improved fidelity. As a result, application of the embodiments disclosed herein is more promising for quantum resource orchestration. These advantages are described in greater detail with reference to one or more figures. Additionally, the various embodiments described herein can be widely adapted across various quantum systems that provide different available hardware technologies.

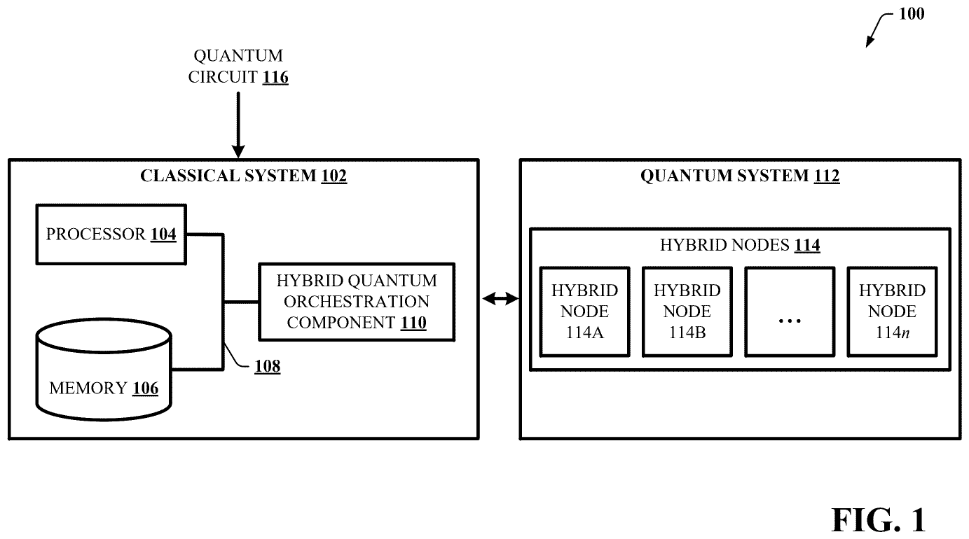

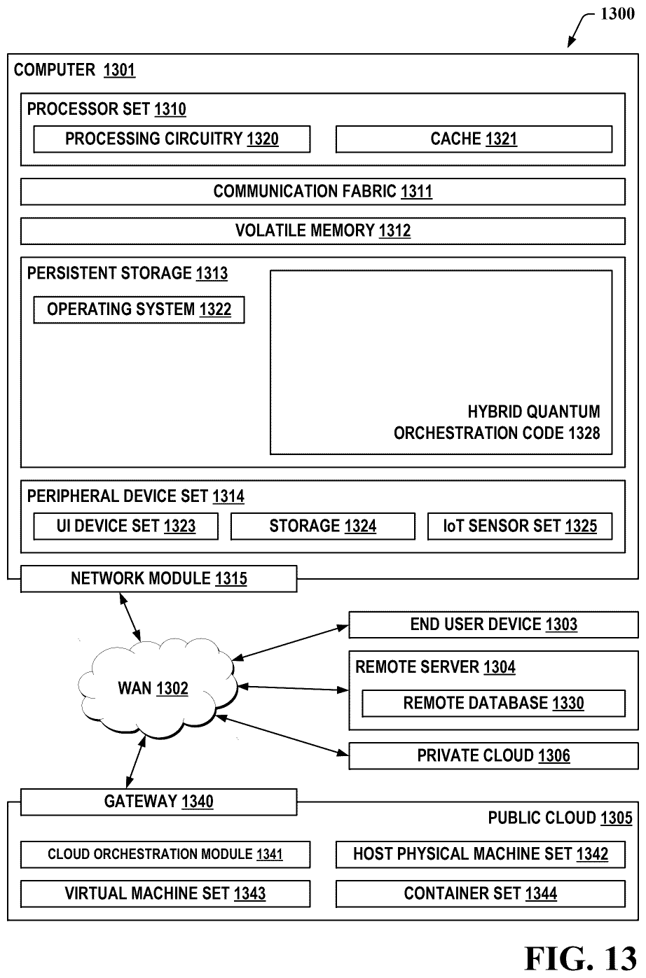

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 1300 illustrated at FIG. 13. For example, non-limiting system 100 can be associated with, such as accessible via, a computing environment 1300 described below with reference to FIG. 13, such that aspects of processing can be distributed between non-limiting system 100 and the computing environment 1300. In one or more described embodiments, computer and/or computing-based elements can be used in connection with implementing one or more of the systems, devices, components and/or computer-implemented operations shown and/or described in connection with FIG. 1 and/or with other figures described herein.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

FIG. 1 illustrates a block diagram of an example, non-limiting system 100 that can facilitate hybrid quantum orchestration for integrating quantum technologies for integrating quantum technologies in accordance with one or more embodiments described herein.

Non-limiting system 100 and/or the components of non-limiting system 100 can be employed to use hardware and/or software to solve problems that are highly technical in nature (e.g., related to quantum computing, hybrid classical-quantum resource allocation, quantum resource orchestration, etc.), that are not abstract and that cannot be performed as a set of mental acts by a human. Further, some of the processes performed may be performed by specialized computers for carrying out defined tasks related to hybrid quantum orchestration. Non-limiting system 100 and/or components of non-limiting system 100 can be employed to solve new problems that arise through advancements in technologies mentioned above, computer architecture, and/or the like. Non-limiting system 100 can provide technical improvements to quantum computing systems by improving the computational efficiency of performing quantum algorithms or quantum circuits, improving fidelity, reducing loss of coherence, etc.

Discussion turns briefly to processor 104, memory 106 and bus 108 of non-limiting system 100. For example, in one or more embodiments, non-limiting system 100 can comprise processor 104 (e.g., computer processing unit, microprocessor, classical processor, and/or like processor). In one or more embodiments, a component associated with non-limiting system 100, as described herein with or without reference to the one or more figures of the one or more embodiments, can comprise one or more computer and/or machine readable, writable and/or executable components and/or instructions that can be executed by processor 104 to enable performance of one or more processes defined by such component(s) and/or instruction(s).

In one or more embodiments, non-limiting system 100 can comprise a computer-readable memory (e.g., memory 106) that can be operably connected to processor 104. Memory 106 can store computer-executable instructions that, upon execution by processor 104, can cause processor 104 and/or one or more other components of non-limiting system 100 (e.g., hybrid quantum orchestration component 110, partition component 202, training component 204, inference component 206, selection component 208, scheduling component 210, and/or AI model 212) to perform one or more actions. In one or more embodiments, memory 106 can store computer-executable components (e.g., hybrid quantum orchestration component 110, partition component 202, training component 204, inference component 206, selection component 208, and/or scheduling component 210).

Non-limiting system 100 and/or a component thereof as described herein, can be communicatively, electrically, operatively, optically and/or otherwise coupled to one another via bus 108. Bus 108 can comprise one or more of a memory bus, memory controller, peripheral bus, external bus, local bus, and/or another type of bus that can employ one or more bus architectures. One or more of these examples of bus 108 can be employed. In one or more embodiments, non-limiting system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of non-limiting system 100 can reside in the cloud, and/or can reside locally in a local computing environment (e.g., at a specified location(s)).

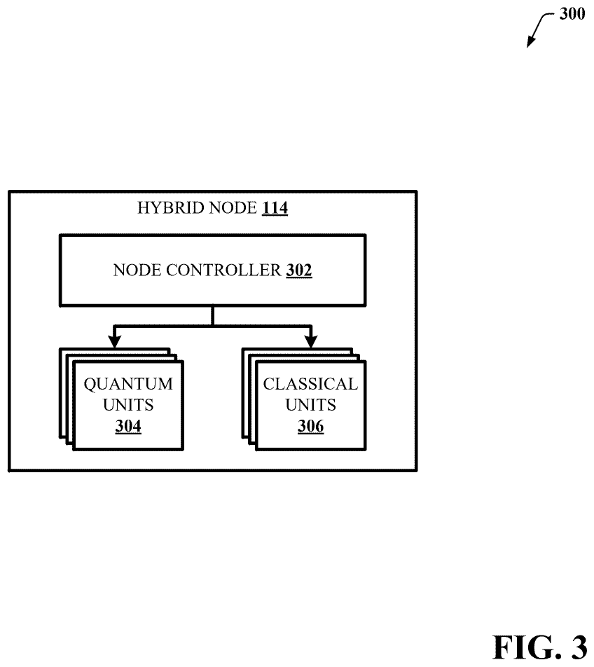

As illustrated in FIG. 1, non-limiting system 100 can comprise classical system 102 and quantum system 112. Classical system 102 can be coupled (operatively, communicatively, electrically, and/or like function) to quantum system 112. Quantum system 112 can comprise one or more hybrid nodes 114, such as hybrid node 114A, hybrid node 114B, . . . , hybrid node 114n, etc, where n represents a positive integer. Each hybrid node 114 can comprise a quantum processor, such as quantum processor 402, as illustrated in FIG. 3.

Classical system 102 can comprise one or more components, such as a memory 106, processor 104, bus 108, and/or hybrid quantum orchestration component 110. In an embodiment, hybrid quantum orchestration component 110 can be comprised at least partially by quantum system 112. Quantum processor 402 can comprise a quantum logic circuit comprising one or more qubits 402, such as qubit 402A, qubit 402B, . . . , qubit 402k, etc., where k represents a positive integer. Quantum processor 402 can be any suitable processor. Quantum processor 402 can generate one or more instructions for controlling the quantum logic circuit.

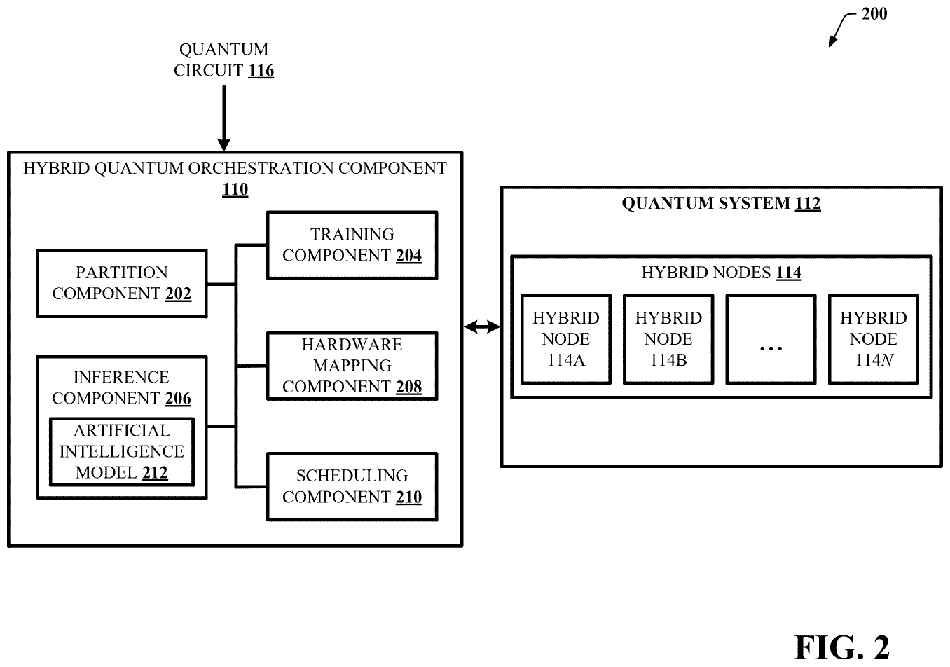

In various embodiments, hybrid quantum orchestration component 110 can comprise partition component 202, training component 204, inference component 206, selection component 208, and scheduling component 210, as illustrated in FIG. 2.

In various embodiments, partition component 202 can receive a quantum circuit 116. In various aspects, partition component 202 can partition, as described herein, the quantum circuit 116 into a set of sub-circuits. The quantum circuit 116 can comprise any desired length or size. For example, quantum circuit 116 can be to long to efficiently or practically implement on a quantum system (e.g., spans thousands of quantum gates). Accordingly, partition component 202 can fragment the quantum circuit 116 into the set of sub-circuits, where each of the set of sub-circuits are smaller than the quantum circuit 116 (e.g., comprise a length or size that is less than that of quantum circuit 116). As a result of partitioning the quantum circuit 116, each sub-circuit can be more suited to running on different quantum technologies or qubit modalities. For instance, a first sub-circuit can be more efficiently executed on superconducting qubits. Conversely, a second sub-circuit can be more efficiently executed on ion-trap qubits.

Therefore, as described herein, selection component 208 can engage inference component 206 to determine, via AI model 212, a qubit modality and/or hardware topology for each sub-circuit based on characteristics of the sub-circuits. That is, AI model 212 can receive any sub-circuit as input and generate a corresponding qubit modality and hardware topology as output based on the hardware technologies that are available. Accordingly, selection component 208 can convert, as described herein, the sub-circuits to a form that can be implemented on the respective hardware topologies.

In various embodiments, training component 204 can facilitate, as described herein, training of AI model 212 using reinforcement learning. In various aspects, reinforcement learning of AI model 212 can comprise decision-making by an agent through interaction with an environment to maximize cumulative rewards, where the environment is the execution of the sub-circuits.

In various embodiments, after training (via training component 204) AI model 212 to a desired level of performance, AI model 212 can, as described herein, receive any sub-circuit as input and generate a corresponding qubit modality and hardware topology as output. In various instances, training component 204 can convert the sub-circuits to image representations to generate additional input to the AI model 212.

In various aspects, scheduling component 210 can schedule the sub-circuits onto the hybrid nodes 114. To improve computational efficiency, scheduling component 210 can receive queue sizes of the hybrid nodes 114 to determine a schedule for the sub-circuits. Further, scheduling component 210 can schedule execution of the sub-circuits based on the respective hardware topologies determined for each sub-circuit. For instance, scheduling component 210 can employ a deep learning neural network to determine the schedules based on the queue size and respective hardware topologies. In any case, scheduling component 210 can schedule execution of the sub-circuits onto quantum processors in the hybrid nodes 114 based on availability of the hybrid nodes 114 to further improve computational efficiency.

FIG. 2 illustrates a block diagram of an example, non-limiting system 200 that can facilitate hybrid quantum orchestration for integrating quantum technologies in accordance with one or more embodiments described herein. Repetitive description of like elements and/or processes employed in respective embodiments is omitted for sake of brevity.

As described with reference to FIG. 1, hybrid quantum orchestration component 110 can comprise partition component 202, training component 204, inference component 206, selection component 208, and scheduling component 210. In this regard, non-limiting system 200 describes the system of hybrid quantum orchestration component 110 and quantum system 112 that can facilitate hybrid quantum orchestration to integrate quantum hardware technologies.

In various embodiments, partition component 202 can receive or electronically access the quantum circuit 116. Thereafter, partition component 202 can partition the quantum circuit 116 into a set of sub-circuits. The sub-circuits can comprise a size or length smaller than the quantum circuit 116. In various aspects, the size or length of each subcircuit can differ among the set of sub-circuits. For instance, a first sub-circuit can comprise a length larger than a second sub-circuit.

In various instances, partition component 202 can employ a deep learning neural network to determine how to partition the quantum circuit 116 based on the hardware technologies in quantum system 112. In various aspects, the deep learning neural network can be a sub-model of AI model 212.

For instance, quantum system 112 can provide the following qubit modalities: superconducting qubits, ion-trap qubits, nuclear magnetic resonance (NMR) qubits, silicon-spin qubits, neutral atom qubits, photonic qubits, or nitrogen-vacancy (NV)-center qubits. In various aspects, partition component 202 can employ a deep learning neural network to learn to partition the quantum circuit 116 based on such qubit modalities available and their respective advantages. In other words, partition component 202 can leverage the different hardware technologies to determine a more optimal partitioning of quantum circuit 116.

For example, superconducting qubits can offer flexibility in qubit connectivity, leveraging available hardware topologies (e.g., linear, heavy-hex, etc.) and faster gate operations for sub-circuits with a large depth. As another example, ion-trap qubits can offer end-to-end connectivity for sub-circuits with a lot of entangling gates, such as a CNOT gate, that are not satisfied by the topologies provided by superconducting hardware. As yet another example, NMR qubits can offer increased coherence times, such as for several seconds, for sub-circuits where a qubit needs to maintain coherence for a very long time before its state is evolved again. As still another example, silicon-spin qubits can offer improved scalability, modular hardware platforms for precise tuning and control of a dense array of qubits, and operation at higher temperatures. As even another example, neutral atom qubits can offer improved coherence times and improved scalability. As yet another example, photonic qubits can offer operation at room temperature and particular communication and processing types of qubits. As still yet another example, NV-center qubits can offer improved coherence time for quantum sensing and solid-state quantum computing applications. In any case, no matter the hardware technologies available, partition component 202 can leverage their respective advantages to determine how to fragment quantum circuit 116 into the set of sub-circuits.

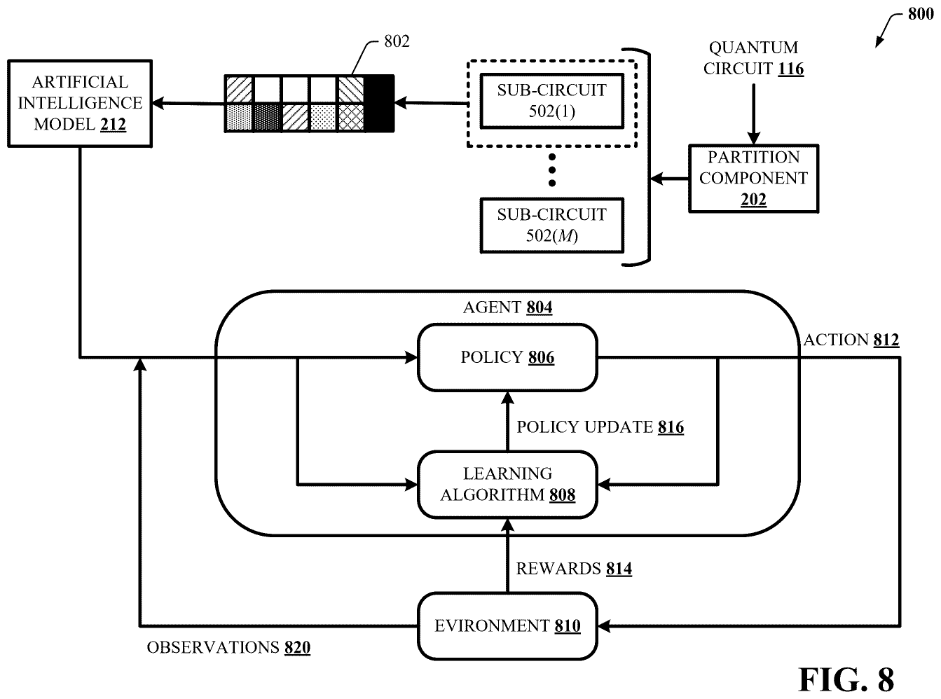

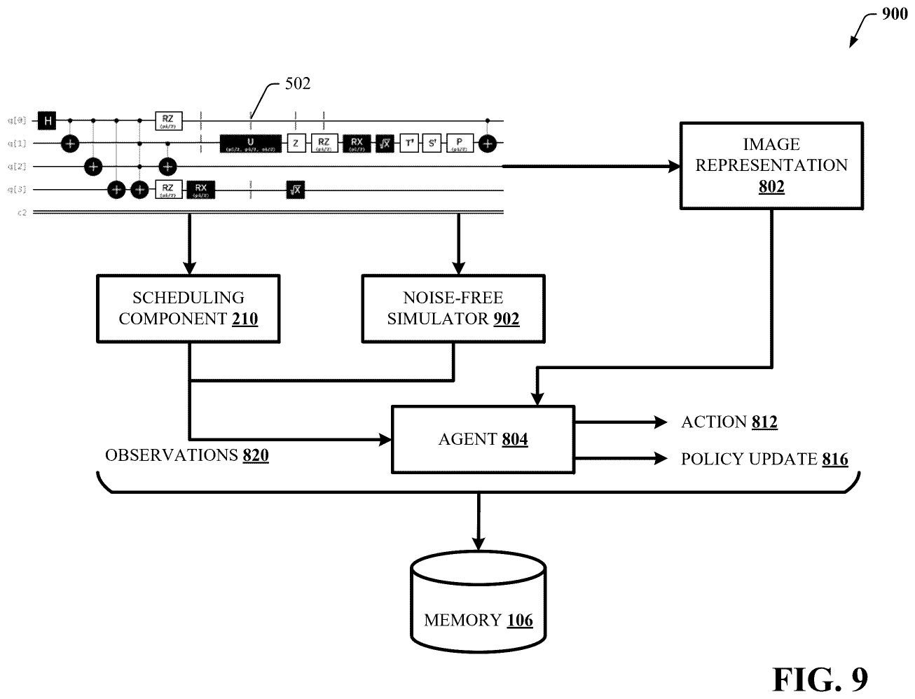

In various embodiments, after partitioning quantum circuit 116 into the set of sub-circuits, selection component 208 can engage the inference component 204 to determine which qubit modality and hardware topology is most suited for each sub-circuit. To achieve this, training component 204 can train the AI model 212 using reinforcement learning. Various aspects of the reinforcement learning used to train AI model 212 are described with respect to FIGS. 8 and 9.

In various embodiments, after determining which qubit modality and hardware topology is most suited for each sub-circuit, scheduling component 210 can schedule the set of sub-circuits onto hybrid nodes 114. In various aspects, to determine scheduling of the set of sub-circuits, scheduling component 210 can employ a second deep learning neural network. In various cases, the second deep learning neural network can be a sub-model of AI model 212.

In various embodiments, scheduling component 210 can electronically store, maintain, control, or otherwise access the second deep learning neural network that can be configured to generate a schedule for execution of the sub-circuits based on queue size and their respective hardware topologies. The second deep learning neural network can exhibit any suitable deep learning neural network architecture and can be trained in any suitable fashion via training component 204.

More specifically, an input layer of the second deep learning neural network can receive a queue size of the hybrid nodes 114 and the respective hardware topologies (determined via selection component 208). The queue size of the hybrid nodes 114 and the respective hardware topologies can complete a forward pass through one or more hidden layers of the second deep learning neural network, and an output layer of the second deep learning neural network can generate the schedule based on activations provided by the one or more hidden layers. So, the predicted schedule can be considered as the schedule that the second deep learning neural network believes should correspond to the queue size and respective hardware topologies.

In various aspects, prior to beginning training, trainable internal parameters (e.g., convolutional kernels, weight matrices, bias values) of the second deep learning neural network can be initialized in any suitable fashion (e.g., via random initialization).

In various aspects, a training dataset used to train the second deep learning neural network can comprise a set of ground-truth annotations that can respectively correspond to a set of training inputs. In various instances, each of the set of ground-truth annotations can be one or more correct or accurate schedules that are known or deemed to correspond to a respective one of the set of training inputs. For instance, the set of ground-truth annotations can comprise a set of schedules that are known to be correct or accurate for a set of queue sizes and respective hardware topologies comprised by the training inputs.

In various aspects, the training component 204 can compute any suitable error or loss (e.g., mean absolute error, mean squared error, cross-entropy error) between the predicted schedules and the ground-truth annotations. In various instances, the training component 204 can incrementally update the trainable internal parameters of the second deep learning neural network, via backpropagation (e.g., stochastic gradient descent) driven by the computed error or loss.

In various cases, such execution-and-update procedure can be repeated for any suitable number of training inputs (e.g., for each training input in the training dataset). This can ultimately cause the trainable internal parameters of the second deep learning neural network to become iteratively optimized for accurately generating schedules for executing the set of sub-circuits based on queue sizes and the respective qubit topologies. In various aspects, the training component 204 can implement any suitable training batch sizes, any suitable error, loss, or objective functions, or any suitable training termination criteria.

Although the above description mainly describes the second deep learning neural network as being trained in supervised fashion, this is a mere non-limiting example for ease of illustration and explanation. In various cases, the training component 204 can implement any other suitable training paradigms (e.g., unsupervised training, reinforcement learning) to train the second deep learning neural network.

FIG. 3 illustrates a diagram of example, non-limiting diagram 300 of a hybrid node in accordance with one or more embodiments described herein. Repetitive description of like elements and/or processes employed in respective embodiments is omitted for sake of brevity.

In various embodiments, each of hybrid nodes 114 can comprise a node controller 302. In various aspects, the node controller 302 can receive the schedule generated by scheduling component 210, and manage resources within the hybrid node accordingly. For instance, the node controller 302 can orchestrate quantum resources and classical resources according the sub-circuit to be executed. Particularly, the node controller 302 can orchestrate quantum resources and classical resources among quantum units 304 and classical units 306. In various aspects, the quantum units 304 can comprise any suitable number of units. Similarly, the classical units 306 can comprise any suitable number of units. In various embodiments, the classical units 306 can comprise a classical processor. In some embodiments, the quantum units 304 can comprise a quantum processor, such as quantum processor 402.

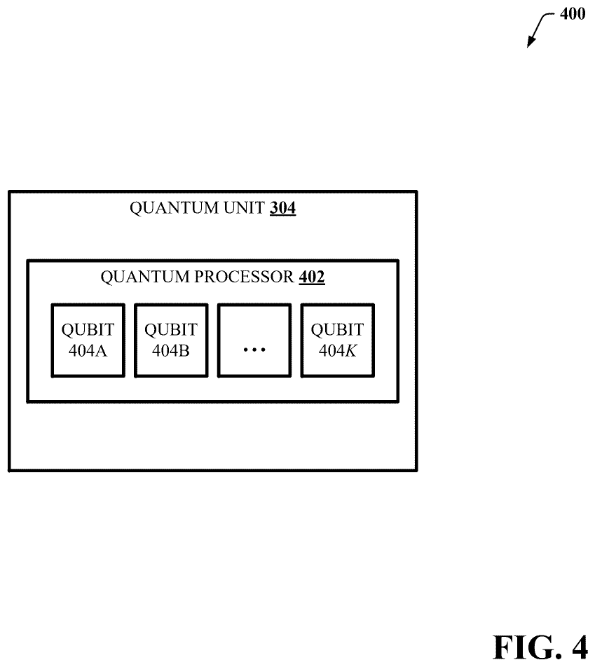

FIG. 4 illustrates a diagram of example, non-limiting diagram 400 of a quantum unit in a hybrid node in accordance with one or more embodiments described herein. Repetitive description of like elements and/or processes employed in respective embodiments is omitted for sake of brevity.

With continued reference to the embodiments of FIGS. 1-3, each of the quantum units 304 can comprise a quantum processor 402. In various aspects, the quantum processor 402 can comprise one or more qubits 404, such as qubit 404A, qubit 404B, . . . , qubit 404k, etc, where k represents a positive integer.

As described with respect to FIG. 2, each of the hybrid nodes 114 can implement different qubit modalities. For instance, hybrid node 114A can employ superconducting qubits and hybrid node 114B can employ silicon-spin qubits. Thus, in various embodiments, scheduling component 210 can receive queue sizes for the hybrid nodes 114 to determine the schedule for the sub-circuits based on the respective hardware topologies and qubit modalities needed for each sub-circuit. In various embodiments, the node controller 302 can electronically send the queue sizes for each of hybrid nodes 114 to scheduling component 210.

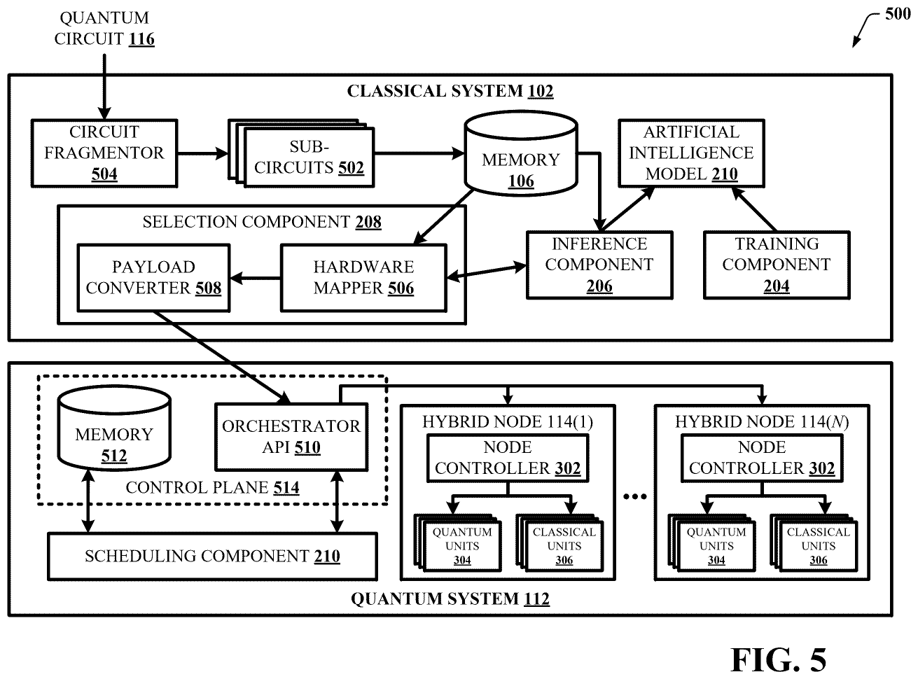

FIG. 5 illustrates a block diagram of an example, non-limiting system architecture 500 that can facilitate hybrid quantum orchestration for integrating quantum technologies in accordance with one or more embodiments described herein. Repetitive description of like elements and/or processes employed in respective embodiments is omitted for sake of brevity.

Depicted in non-limiting system architecture 500 is a system architecture that can facilitate training of AI model 212. In some cases, non-limiting system architecture 500 can facilitate cloud training by using cloud resources to train the AI model 212.

In various embodiments, partition component 202 can receive quantum circuit 116 to generate sub-circuits 502. More specifically, partition component 202 an electronically store, maintain, control, or otherwise access a circuit fragmentor 504 that can generate the sub-circuits 502. A circuit fragmentor is a tool that can decompose the quantum circuit 116 into the sub-circuits 502. For instance, circuit fragmentor 504 can apply circuit cutting to quantum circuit 116 to generate sub-circuits 502. In various aspects, circuit fragmentor 504 can apply circuit cutting by cutting gates or wires of quantum circuit 116, resulting in the sub-circuits 502. Thus, as described herein, results from executing the sub-circuits 502 can be combined to reconstruct a result for the quantum circuit 116.

In various aspects, the sub-circuits 502 can be stored in memory 106. In various instances, the memory 106 can comprise a database for persistent storage of sub-circuits 502 and a cache for temporarily holding frequently accessed subcircuit information. Accordingly, inference component 206 can access memory 106 to access the sub-circuits 502. Thereafter, inference component 206 can input the sub-circuits 502 into AI model 212, wherein training component 204 can then facilitate reinforcement learning for AI model 212 using the sub-circuits 502. In various embodiments, the AI model 212 can output the respective qubit modalities and hardware topologies of the sub-circuits 502, which inference component 206 can then send to selection component 208. In various aspects, the selection component 208 an electronically store, maintain, control, or otherwise access a hardware mapper 506 that can select the qubit modalities for each sub-circuit of sub-circuits 502. For instance, hardware mapper 506 can select the qubit modalities for each sub-circuit based on the qubit modalities available in quantum system 112 (e.g., superconducting, photonic, neutral atom, silicon-spin, ion trap, NMR, etc.). For instance, if a sub-circuit necessitates certain qubit communications, hardware mapper 506 can select the qubit modalities based on such requirements. Furthermore, hardware mapper 506 can select the hardware topologies for each sub-circuit based on the qubit modalities. For instance, the hardware mapper 506 can determine if a sub-circuit can map to a particular hardware topology of quantum system 112 based on qubit connectivity.

In various aspects, selection component 208 can further electronically store, maintain, control, or otherwise access a payload converter 508. In various embodiments, the payload converter 508 can convert high-level quantum instructions into technology-specific low-level instructions. In various aspects, such technology-specific low-level instructions can be tailored to the respective qubit modalities of the sub-circuits 502. More specifically, payload converter 508 can generate sets of instructions for each qubit modality. As a non-limiting example, payload converter can generate a set of instructions for superconducting qubits and another set of instructions for ion-trap qubits. To achieve this, payload converter 508 can utilize a basic gate converter to translate a quantum language circuit (e.g., high-level instructions) to low-level hardware-specific gate instructions that can be implemented on the respective hardware topologies and qubit modalities. In various aspects, the basic gate converter can convert the quantum language circuit into sets of instructions that are adapted to match each qubit modality. To standardize the conversion, the payload converter 508 can use a quantum assembler (e.g., quantum standard machine (QSM)) to facilitate conversion of a standard quantum language circuit into the technology-specific low-level instructions.

In various embodiments, the payload converter 508 can send the low-level instructions (or the instructions that can implemented on the respective hardware topologies and qubit modalities) to an orchestrator Application Programming Interface (API) 510. In various aspects, orchestrator API 510 can route the sub-circuits 502, based on the instructions, to correct hybrid nodes of hybrid nodes 114. In various embodiments, the orchestrator API 510 can route the sub-circuits 502 based on the schedule determined by scheduling component 210 (e.g., the second neural network). As described with respect to FIG. 2, the scheduling component 210 can determine the schedule for the sub-circuits 502 based on queue size of the hybrid nodes 114 and can thus improve computational efficiency by scheduling the sub-circuits 502 based on available hybrid nodes.

In various embodiments, the orchestrator API 510 and a memory 512 can be comprised by a control plane 514. The control plane 514 can be responsible for managing and directing data traffic, coordinating system resources, and overseeing operations. In various aspects, scheduling component 210 can access the control plane 514 to facilitate resource management according to the schedule generated based on queue size and the respective hardware topologies of the sub-circuits 502. For instance, scheduling component 210 can access the memory 512 and the orchestrator API 510 to implement the schedule on the hybrid nodes 114. In some aspects, the memory 512 can comprise a database and a cache. In any instance, orchestrator API 510 can interact with the hybrid nodes 114 by sending scheduling directives that define the sequence and timing of tasks to be executed across various computing resources, as determined by scheduling component 210. Through orchestrator API 510, the control plane 514 can dynamically allocate workloads between different qubit modalities and hardware topologies across the hybrid nodes 114. In particular, the control plane 514 can dynamically allocate workloads to the hybrid nodes 114, and the node controller 302 can allocate workloads to the quantum units 304 and the classical units 306 within each of hybrid nodes 114. Furthermore, the orchestrator API 510 can monitor the status of each hybrid node 114. Accordingly, the orchestrator API 510 can send the status of the hybrid nodes 114 to the scheduling component 210 to facilitate scheduling of subsequent sub-circuits or quantum circuits.

As a result of executing the sub-circuits 502 on the respective qubit modalities and hardware topologies on the hybrid nodes 114, the results from each execution of each sub-circuit can thus be combined to form a single result corresponding to the quantum circuit 116. In various cases, executions of the sub-circuits 502 can be performed in parallel to each other.

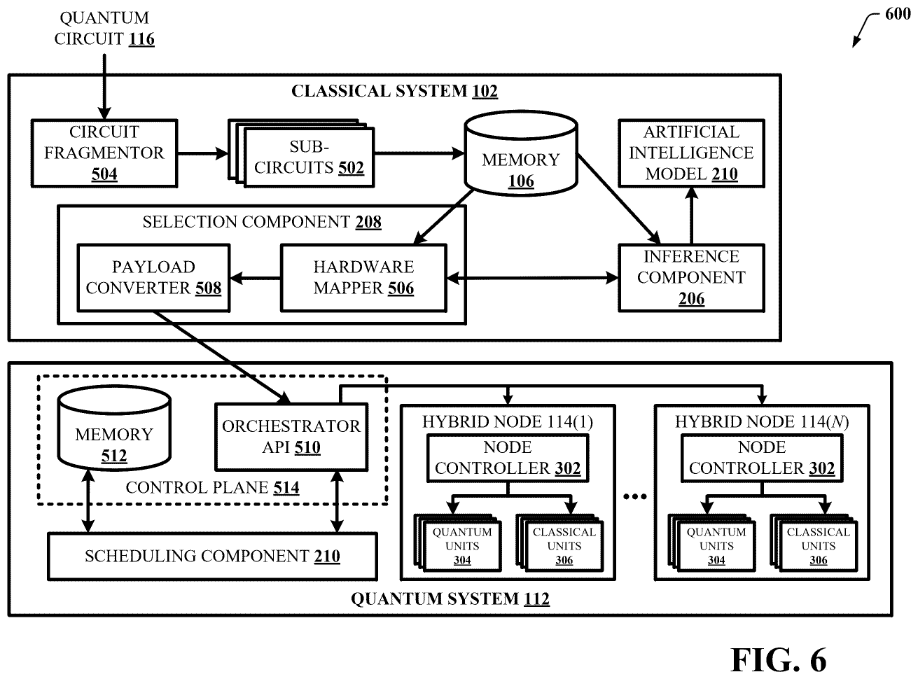

FIG. 6 illustrates a block diagram of an example, non-limiting system architecture 600 that can facilitate hybrid quantum orchestration for integrating quantum technologies in accordance with one or more embodiments described herein. Repetitive description of like elements and/or processes employed in respective embodiments is omitted for sake of brevity.

In various embodiments, non-limiting system architecture 600 can facilitate inferencing using AI model 212 after training. In some cases, non-limiting system architecture 600 can facilitate cloud inferencing using AI model 212 after training.

As shown, the non-limiting system architecture 600 can be similar or exhibit a similar architecture to non-limiting system architecture 500. However, since the AI model 212 has undergone training, non-limiting system architecture 600 can remove implementation of training component 204. Accordingly, the sub-circuits 502 received as input can be used to generate an inference of the respective qubit modalities and hardware topologies of the sub-circuits 502, as opposed to facilitate training of AI model 212 on the sub-circuits 502.

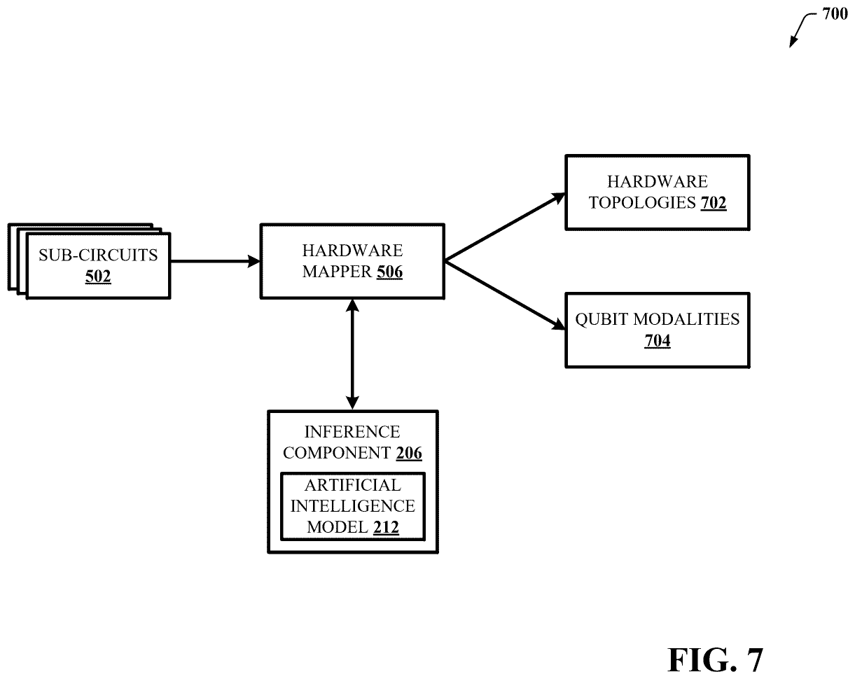

FIG. 7 illustrates a diagram of an example, non-limiting system 700 for determining hardware topologies and qubit modalities of sub-circuits in accordance with one or more embodiments described herein. Repetitive description of like elements and/or processes employed in respective embodiments is omitted for sake of brevity.

In reference to FIGS. 5 and 6, the hardware mapper 506 (e.g., selection component 208) can receive the sub-circuits 502. In various aspects, hardware mapper 506 can engage inference component 206 to generate respective hardware topologies 702 and qubit modalities 704 of the sub-circuits 502. Accordingly, the payload converter 508 can convert the sub-circuits 502 from a high-level language into low-level language that can be implemented on the respective hardware topologies 702 and qubit modalities 704. That is, payload converter 508 can generate instructions for each of the qubit modalities 704 that can be implemented on the respective hardware topologies 702. Thus, scheduling component 210 can schedule quantum-classical resources across the respective hardware topologies 702 and qubit modalities 704 to execute the sub-circuits 502 on the hybrid nodes 114 (e.g., on quantum units 304 and classical units 306).

FIG. 8 illustrates a diagram of an example, non-limiting reinforcement learning algorithm 800 for training an artificial intelligence model in accordance with one or more embodiments described herein. Repetitive description of like elements and/or processes employed in respective embodiments is omitted for sake of brevity.

In various embodiments, the partition component 202 can partition (e.g., via circuit fragmentor 504) the quantum circuit 116 into the sub-circuits 502. The partition component 202 can partition the quantum circuit 116 into any suitable number of sub-circuits 502, such as sub-circuit 502(1), 502(2), . . . , 502(m), etc, where m represents a positive integer.

In various embodiments, training component 204 can train the AI model 212 on the sub-circuits 502. In various aspects, training component 204 can generate an image representation of each sub-circuit to facilitate reinforcement learning. As shown, for example, training component 204 can generate an image representation 802 of sub-circuit 502(1). In some instances, the image representations of the sub-circuits 502 can be multichannel image representations. A multichannel image representation of a quantum circuit is an image format of the quantum circuit that used multiple layers or channels of information to encode different features of the quantum circuit. As a non-limiting example, the image representation can utilize different colorings to represent the different features of the quantum circuit. As shown in image representation 802, different patterning is used to represent the different features of sub-circuit 502(1). As non-limiting examples, the different features of the sub-circuits 502 can correspond to hardware type, qubit modality, qubit connectivity, gate types, circuit depth, error rates, etc. In any case, the AI model 212 can receive the image representations (e.g., image representation 802) as input for training.

Reinforcement learning is a type of machine learning where an agent 804 learns to make decisions by interacting with an environment 810 to maximize cumulative rewards. In various aspects, training component can initialize the agent 804, starting with an initial policy that may be random or based on prior knowledge, and setup the environment 810. In various embodiments, the agent 804 can take actions 812 within environment 810 based on a policy 806, wherein policy 806 represents the current policy. As a result of the actions 812, rewards 814 can be generated by environment 810, reflecting outcomes of the actions 812. Following each action 812, the agent 804 can receive the rewards 814 and observations 820 resulting from an update state of the environment 810.

In various embodiments, the image representations of each sub-circuit can further be received by the agent 804 as additional input for training. Further, the AI model 212 (e.g., a deep learning neural network of the AI model 212) can process the image representations to extract the features from the sub-circuits 502. Thus, the agent 804 can have an enhanced understanding of characteristics of the sub-circuits 502 to improve the decision-making process by agent 804.

In various embodiments, the environment 810 can consist of the sub-circuits 502 being executed on the hybrid nodes 114. Accordingly, as the agent 804 receives each image representation, such as image representation 802 with observations 820 from the environment 810, the agent 804 can take action 812. As a result, environment 810 can generate more observations 820 of the current state of the environment 810 and rewards 814. In various aspects, a learning algorithm 808 can receive the rewards 814 to determine a policy update 816 of policy 806. In various instances, the learning algorithm 808 can be any suitable learning algorithm, including but not limited to Deep Q-Network (DQN), policy gradient methods, actor-critic methods, Proximal Policy Optimization (PPO), or State-Action-Reward-State-Action (SARSA). Furthermore, in some cases, the learning algorithm 808 can receive the observations 820 and actions 812 to determine the policy update 816. Thus, the agent 804 will take actions 812 according to the policy 806 after the policy update 816.

In various embodiments, the observations 820 can include SWAP gate counts, single-qubit gate counts, two-qubit gate counts, and idling gate counts. Furthermore, the rewards 814 can include negative rewards and positive rewards. In this framework, the rewards 814 are determined by both the complexity of the sub-circuits 502 and the capabilities of the respective hardware technologies (e.g., hardware topologies 702, qubit modalities 704). For instance, in ion trap systems, where certain gates like CNOT cannot be implemented, the agent 804 must ensure that such gates are not included in the sub-circuits 502. Thus, the rewards 814 can reflect these constraints, assigning higher rewards when the learning algorithm 808 reduces circuit complexity while adhering to the specific technological limitations. Additionally, the rewards 814 can be continuously adjusted to adhere or adapt to new hardware technologies that may be developed and implemented into quantum system 112. As non-limiting examples, positive rewards can be generated as a result of reducing SWAP gate counts or providing results that are closer than previous iterations to an ideal result. In other cases, negative rewards can be generated if the results are incorrect. As a non-limiting example, if the actions 812 result in prohibited gates for a particular qubit modality, the rewards 814 can be negative.

FIG. 9 illustrates a diagram of an example, non-limiting workflow 900 of reinforcement learning algorithm for training an artificial intelligence model in accordance with one or more embodiments described herein. Repetitive description of like elements and/or processes employed in respective embodiments is omitted for sake of brevity.

In various embodiments, as described with respect to FIG. 8, a sub-circuit from the sub-circuits 502 can be converted into the image representation 802 and received as additional input to the agent 804. Furthermore, the sub-circuit can be executed, via scheduling component 210, on available hybrid nodes of hybrid nodes 114. The available hybrid nodes 114 can be determined by scheduling component 210 based on the queue sizes of the hybrid nodes 114. Additionally, the sub-circuit can be executed on a noise-free simulator 902. A noise-free simulator is a computational tool designed to simulate quantum circuits under ideal conditions, without accounting for real-world imperfections or noise that can affect quantum operations. In various cases, the sub-circuit can be executed on the noise-free simulator 902 if it comprises a sufficiently small size. In either case, observations 820 from executing the sub-circuit on the hybrid nodes 114 and the noise-free simulator 902 can be obtained. Accordingly, the agent 804 can receive the observations 820 and the image representation 802, and thus yield actions 812 and policy update 816 as described with respect to FIG. 8. That is, the agent 804 can generate the policy update 816 based on rewards 814 generated as a result of actions 812. Further, as shown, the observations 820, the actions 812, and the policy update 816 can be stored in memory 106 for subsequent access, such as for inferencing after training of AI model 212.

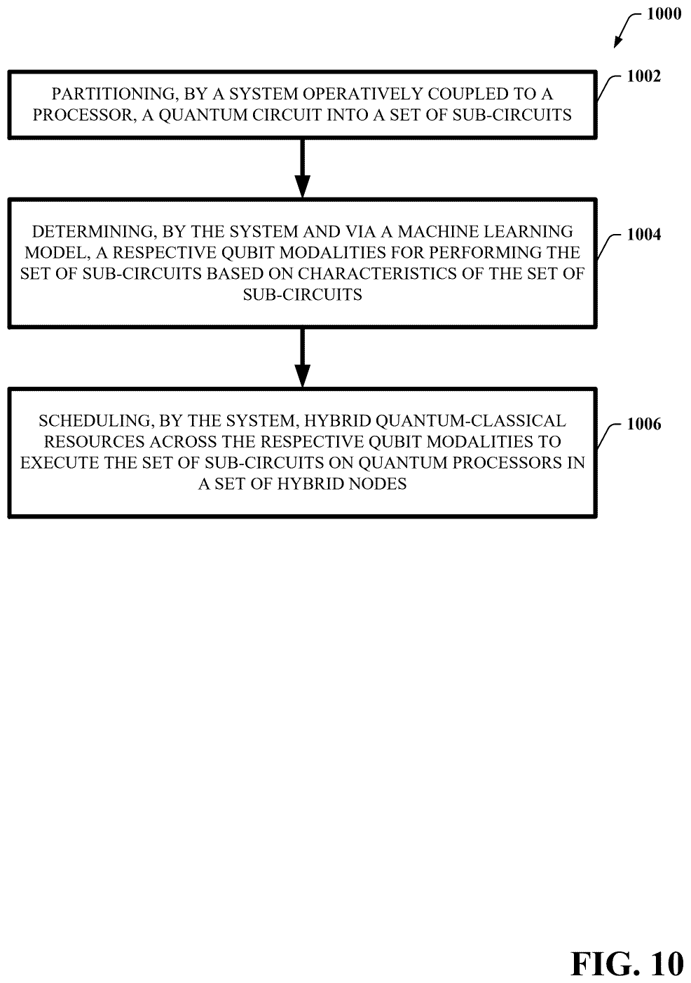

FIG. 10 illustrates a flow diagram of an example, non-limiting method 1000 that can facilitate hybrid quantum orchestration for integrating quantum technologies in accordance with one or more embodiments described herein.

At 1002, non-limiting method 1000 can comprise partitioning (e.g., by partition component 202), by a system operatively coupled to a processor, a quantum circuit (e.g., 116) into a set of sub-circuits (e.g., 502).

At 1004, non-limiting method 1000 can comprise determining (e.g., by inference component 206), by the system and via an AI model (e.g., 212), respective qubit modalities for performing the set of sub-circuits based on characteristics of the set of sub-circuits.

At 1006, non-limiting method 1000 can comprise scheduling (e.g., by measurement component 202), by the system, hybrid quantum-classical resources across the respective qubit modalities to execute the set of sub-circuits on quantum processors (e.g., 308) in a set of hybrid nodes (e.g., 114).

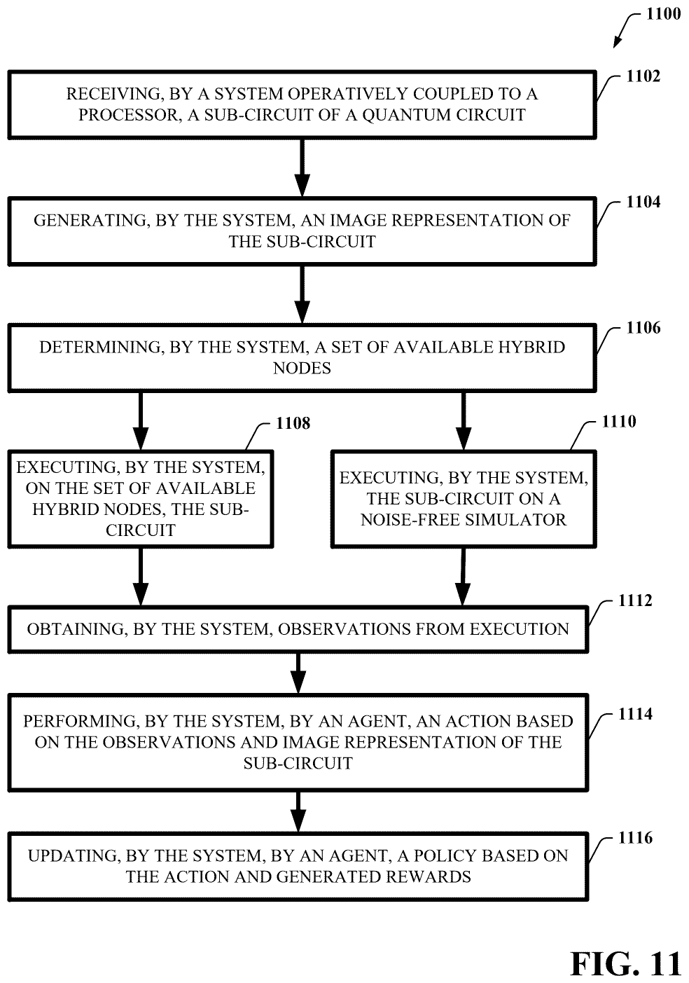

FIG. 11 illustrates a flow diagram of an example, non-limiting method 1100 that can facilitate hybrid quantum orchestration for integrating quantum technologies in accordance with one or more embodiments described herein. Repetitive description of like elements and/or processes employed in respective embodiments is omitted for sake of brevity.

At 1102, non-limiting method 1100 can comprise receiving (e.g., by training component 204), by a system operatively coupled to a processor, a sub-circuit of a quantum circuit.

At 1104, non-limiting method 1100 can comprise generating (e.g., by training component 204), by the system, an image representation of the sub-circuit.

At 1106, non-limiting method 1100 can comprise determining (e.g., by scheduling component 210), by the system, a set of available hybrid nodes. In various embodiments, the scheduling component 210 can determine the availability of the hybrid nodes based on the hardware topologies 702, the qubit modalities 704 and the queue sizes of the hybrid nodes.

At 1108, non-limiting method 1100 can comprise executing (e.g., by scheduling component 210), by the system, and on the set of available hybrid nodes, the sub-circuit.

At 1110, non-limiting method 1100 can comprise executing (e.g., by scheduling component 210), by the system, the sub-circuit on a noise-free simulator.

At 1112, non-limiting method 1100 can comprise obtaining (e.g., by training component 204), by the system, observations from execution.

At 1114, non-limiting method 1100 can comprise performing (e.g., by training component 204), by the system, by an agent, an action based on the observations and image representation of the sub-circuit.

At 1116, non-limiting method 1100 can comprise updating (e.g., by training component 204), by the system, and by the agent, a policy based on the action and generated rewards.

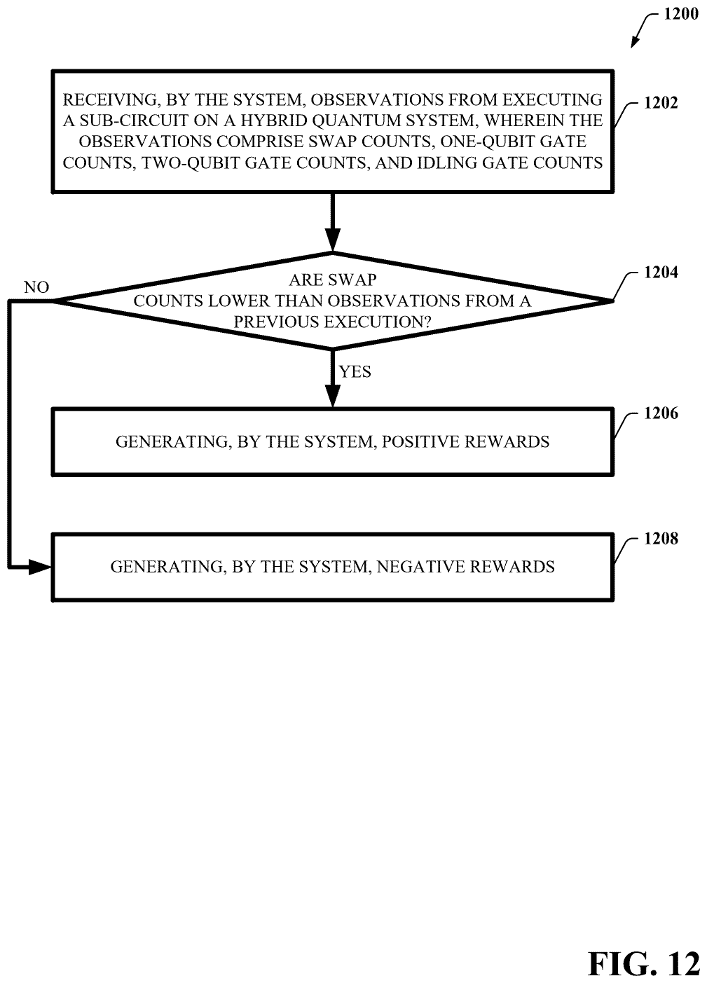

FIG. 12 illustrates a flow diagram of an example, non-limiting method 1200 that can facilitate hybrid quantum orchestration for integrating quantum technologies in accordance with one or more embodiments described herein. Repetitive description of like elements and/or processes employed in respective embodiments is omitted for sake of brevity.

At 1202, non-limiting method 1200 can comprise receiving (e.g., by training component 204), by a system operatively coupled to a processor, observations from executing a sub-circuit on a hybrid quantum system, wherein the observations comprise swap counts, one-qubit gate counts, two-qubit gate counts, and idling gate counts.

At 1204, non-limiting method 1200 can comprise determining (e.g., by training component 204), by the system, whether SWAP gate counts are lower than observations from a previous execution.

If yes, then at 1206, non-limiting method 1300 can comprise generating (e.g., by training component 204), positive rewards.

If no, then at 1208, non-limiting method 1300 can comprise generating (e.g., by training component 204), negative rewards.

In some instances, if the sub-circuit is executed on the noise-free simulator 902 as well, positive rewards can be generated if the result of execution on the hybrid nodes 114 is closer to the result from execution on the noise-free simulator 902 than previous executions. Conversely, negative rewards can be generated if it is further from the result from execution on the noise-free simulator 902.

FIG. 13 illustrates a block diagram of an example, non-limiting, operating environment 1300 in which one or more embodiments described herein can be facilitated. FIG. 13 and the following discussion are intended to provide a general description of a suitable operating environment 1300 in which one or more embodiments described herein at FIGS. 1-13 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1300 contains an example of an environment for the execution of at least some of the computer code involved in performing the inventive methods, such as hybrid quantum orchestration code 1328. In addition to block 1328, computing environment 1300 includes, for example, computer 1301, wide area network (WAN) 1302, end user device (EUD) 1303, remote server 1304, public cloud 1305, and private cloud 1306. In this embodiment, computer 1301 includes processor set 1310 (including processing circuitry 1320 and cache 1321), communication fabric 1311, volatile memory 1312, persistent storage 1313 (including operating system 1322 and block 1328, as identified above), peripheral device set 1314 (including user interface (UI) device set 1323, storage 1324, and Internet of Things (IoT) sensor set 1325), and network module 1315. Remote server 1304 includes remote database 1330. Public cloud 1305 includes gateway 1340, cloud orchestration module 1341, host physical machine set 1342, virtual machine set 1343, and container set 1344.

COMPUTER 1301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1330. As is well understood in the art of computer technology, and depending upon the technology, performance of a computer-implemented method may be distributed among multiple computers and/or between multiple locations. On the other hand, in this presentation of computing environment 1300, detailed discussion is focused on a single computer, specifically computer 1301, to keep the presentation as simple as possible. Computer 1301 may be located in a cloud, even though it is not shown in a cloud in FIG. 13. On the other hand, computer 1301 is not required to be in a cloud except to any extent as may be affirmatively indicated.

PROCESSOR SET 1310 includes one, or more, computer processors of any type now known or to be developed in the future. Processing circuitry 1320 may be distributed over multiple packages, for example, multiple, coordinated integrated circuit chips. Processing circuitry 1320 may implement multiple processor threads and/or multiple processor cores. Cache 1321 is memory that is located in the processor chip package(s) and is typically used for data or code that should be available for rapid access by the threads or cores running on processor set 1310. Cache memories are typically organized into multiple levels depending upon relative proximity to the processing circuitry. Alternatively, some, or all, of the cache for the processor set may be located “off chip.” In some computing environments, processor set 1310 may be designed for working with qubits and performing quantum computing.

Computer-readable program instructions are typically loaded onto computer 1301 to cause a series of operational steps to be performed by processor set 1310 of computer 1301 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 1321 and the other storage media discussed below. The program instructions, and associated data, are accessed by processor set 1310 to control and direct performance of the inventive methods. In computing environment 1300, at least some of the instructions for performing the inventive methods may be stored in block 1328 in persistent storage 1313.

COMMUNICATION FABRIC 1311 is the signal conduction path that allows the various components of computer 1301 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 1312 is any type of volatile memory now known or to be developed in the future. Examples include dynamic type random access memory (RAM) or static type RAM. Typically, volatile memory 1312 is characterized by random access, but this is not required unless affirmatively indicated. In computer 1301, the volatile memory 1312 is located in a single package and is internal to computer 1301, but, alternatively or additionally, the volatile memory may be distributed over multiple packages and/or located externally with respect to computer 1301.

PERSISTENT STORAGE 1313 is any form of non-volatile storage for computers that is now known or to be developed in the future. The non-volatility of this storage means that the stored data is maintained regardless of whether power is being supplied to computer 1301 and/or directly to persistent storage 1313. Persistent storage 1313 may be a read only memory (ROM), but typically at least a portion of the persistent storage allows writing of data, deletion of data and re-writing of data. Some familiar forms of persistent storage include magnetic disks and solid state storage devices. Operating system 1322 may take several forms, such as various known proprietary operating systems or open source Portable Operating System Interface-type operating systems that employ a kernel. The code included in block 1328 typically includes at least some of the computer code involved in performing the inventive methods.

PERIPHERAL DEVICE SET 1314 includes the set of peripheral devices of computer 1301. Data communication connections between the peripheral devices and the other components of computer 1301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1323 may include components such as a display screen, speaker, microphone, wearable devices (such as goggles and smart watches), keyboard, mouse, printer, touchpad, game controllers, and haptic devices. Storage 1324 is external storage, such as an external hard drive, or insertable storage, such as an SD card. Storage 1324 may be persistent and/or volatile. In some embodiments, storage 1324 may take the form of a quantum computing storage device for storing data in the form of qubits. In embodiments where computer 1301 is required to have a large amount of storage (for example, where computer 1301 locally stores and manages a large database) then this storage may be provided by peripheral storage devices designed for storing very large amounts of data, such as a storage area network (SAN) that is shared by multiple, geographically distributed computers. IoT sensor set 1325 is made up of sensors that can be used in Internet of Things applications. For example, one sensor may be a thermometer and another sensor may be a motion detector.

NETWORK MODULE 1315 is the collection of computer software, hardware, and firmware that allows computer 1301 to communicate with other computers through WAN 1302. Network module 1315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1315 are performed on the same physical hardware device. In other embodiments (for example, embodiments that utilize software-defined networking (SDN)), the control functions and the forwarding functions of network module 1315 are performed on physically separate devices, such that the control functions manage several different network hardware devices. Computer-readable program instructions for performing the inventive methods can typically be downloaded to computer 1301 from an external computer or external storage device through a network adapter card or network interface included in network module 1315.

WAN 1302 is any wide area network (for example, the internet) capable of communicating computer data over non-local distances by any technology for communicating computer data, now known or to be developed in the future. In some embodiments, the WAN 1302 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1303 is any computer system that is used and controlled by an end user (for example, a customer of an enterprise that operates computer 1301), and may take any of the forms discussed above in connection with computer 1301. EUD 1303 typically receives helpful and useful data from the operations of computer 1301. For example, in a hypothetical case where computer 1301 is designed to provide a recommendation to an end user, this recommendation would typically be communicated from network module 1315 of computer 1301 through WAN 1302 to EUD 1303. In this way, EUD 1303 can display, or otherwise present, the recommendation to an end user. In some embodiments, EUD 1303 may be a client device, such as thin client, heavy client, mainframe computer, desktop computer and so on.

REMOTE SERVER 1304 is any computer system that serves at least some data and/or functionality to computer 1301. Remote server 1304 may be controlled and used by the same entity that operates computer 1301. Remote server 1304 represents the machine(s) that collect and store helpful and useful data for use by other computers, such as computer 1301. For example, in a hypothetical case where computer 1301 is designed and programmed to provide a recommendation based on historical data, then this historical data may be provided to computer 1301 from remote database 1330 of remote server 1304.

PUBLIC CLOUD 1305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1305 is performed by the computer hardware and/or software of cloud orchestration module 1341. The computing resources provided by public cloud 1305 are typically implemented by virtual computing environments that run on various computers making up the computers of host physical machine set 1342, which is the universe of physical computers in and/or available to public cloud 1305. The virtual computing environments (VCEs) typically take the form of virtual machines from virtual machine set 1343 and/or containers from container set 1344. It is understood that these VCEs may be stored as images and may be transferred among and between the various physical machine hosts, either as images or after instantiation of the VCE. Cloud orchestration module 1341 manages the transfer and storage of images, deploys new instantiations of VCEs and manages active instantiations of VCE deployments. Gateway 1340 is the collection of computer software, hardware, and firmware that allows public cloud 1305 to communicate through WAN 1302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1306 is similar to public cloud 1305, except that the computing resources are only available for use by a single enterprise. While private cloud 1306 is depicted as being in communication with WAN 1302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1305 and private cloud 1306 are both part of a larger hybrid cloud.

CLOUD COMPUTING SERVICES AND/OR MICROSERVICES (not separately shown in FIG. 13): private and public clouds 1306 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor that executes at least one of the computer executable components that:
partitions a quantum circuit into a set of sub-circuits;
determines, via an artificial intelligence model, respective qubit modalities for performing the set of sub-circuits based on characteristics of the set of sub-circuits; and
schedules hybrid quantum-classical resources across the respective qubit modalities to execute the set of sub-circuits on quantum processors in a set of hybrid nodes.

2. The system of claim 1, wherein at least one of the computer executable components further:
determines, via the artificial intelligence model, respective hardware topologies for performing the set of sub-circuits based on characteristics of the respective qubit modalities.

3. The system of claim 1, wherein the set of hybrid nodes comprise respective node controllers to schedule the hybrid quantum-classical resources.

4. The system of claim 2, wherein at least one of the computer executable components further:
converts a quantum language circuit into a form that can be implemented on the respective hardware topologies.

5. The system of claim 2, wherein at least one of the computer executable components further:
schedules execution of the set of sub-circuits on the set of hybrid nodes based on a queue size or the respective hardware topologies.

6. The system of claim 1, wherein at least one of the computer executable components further:
trains the artificial intelligence model using reinforcement learning, wherein training the artificial intelligence model using reinforcement learning comprises:
generating an image representation of a sub-circuit from the set of sub-circuits;
obtaining observations from executing the sub-circuit on a hybrid node;
receiving observations as rewards from execution of the sub-circuit on a hybrid node; and
updating a policy of the artificial intelligence model based on the observations.

7. The system of claim 6, wherein the observations comprise at least one of: a SWAP count, a number of one-qubit gates, a number of two-qubit gates, or a number of idling gates.

8. The system of claim 7, wherein the rewards are positive if the SWAP count is reduced, and wherein the rewards are negative if the observations do not satisfy a performance criterion.

9. The system of claim 6, wherein at least one of the computer executable components further:
executes the sub-circuit on a noise-free simulator; and
obtains the observations from executing the sub-circuit on the noise-free simulator.

10. The system of claim 6, wherein training the artificial intelligence model using reinforcement learning comprises:
executing the sub-circuit on a random hardware topology based on availability.

11. A computer-implemented method, comprising:
partitioning, by a system operatively coupled to a processor, a quantum circuit into a set of sub-circuits;
determining, by the system and via an artificial intelligence model, respective qubit modalities for performing the set of sub-circuits based on characteristics of the set of sub-circuits; and
scheduling, by the system, schedules hybrid quantum-classical resources across the respective qubit modalities to execute the set of sub-circuits on quantum processors in a set of hybrid nodes.

12. The computer-implemented method of claim 11, further comprising:
determining, by the system and via the artificial intelligence model, respective hardware topologies for performing the set of sub-circuits based on characteristics of the respective qubit modalities.

13. The computer-implemented method of claim 11, wherein the set of hybrid nodes comprise respective node controllers to schedule the hybrid quantum-classical resources.

14. The computer-implemented method of claim 12, further comprising:
converting, by the system, a quantum language circuit into a form that can be implemented on the respective hardware topologies.

15. The computer-implemented method of claim 12, further comprising:
scheduling, by the system, execution of the set of sub-circuits on the set of hybrid nodes based on a queue size or the respective hardware topologies.

16. The computer-implemented method of claim 11, further comprising:
training, by the system, the artificial intelligence model using reinforcement learning, wherein training the artificial intelligence model using reinforcement learning comprises:
generating an image representation of a sub-circuit from the set of sub-circuits;
obtaining observations from executing the sub-circuit on a hybrid node;
receiving observations as rewards from execution of the sub-circuit on a hybrid node; and
updating a policy of the artificial intelligence model based on the observations.

17. The computer-implemented method of claim 16, wherein the observations comprise at least one of: a SWAP count, a number of one-qubit gates, a number of two-qubit gates, or a number of idling gates.

18. The computer-implemented method of claim 17, wherein the rewards are positive if the SWAP count is reduced, and wherein the rewards are negative if the observations do not satisfy a performance criterion.

19. A computer program product for hybrid quantum orchestration, the computer program product comprising a computer readable storage medium having program instructions embodied therewith, the program instructions executable by a processor to cause the processor to:
partition a quantum circuit into a set of sub-circuits;
determine, via an artificial intelligence model, respective qubit modalities for performing the set of sub-circuits based on characteristics of the set of sub-circuits; and
schedule hybrid quantum-classical resources across the respective qubit modalities to execute the set of sub-circuits on quantum processors in a set of hybrid nodes.

20. The computer program product of claim 19, wherein the program instructions executable by the processor further causes the processor to:
determine, via the artificial intelligence model, respective hardware topologies for performing the set of sub-circuits based on characteristics of the respective qubit modalities.
